(19) United States
(12) Patent Application Publication
(10) Pub. No.: US 2005/0198216 A1
(43) Pub. Date: Sep. 8, 2005

(54) Method for managing a network using a plurality of databases

(76) Inventors: Manas Kumar Behera, Fort Collins, CO (US); Yong Boon Ho, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/768,934

(22) Filed: Feb. 2, 2004

(51) Int. Cl. G06F 15/177; G06F 15/173

(52) U.S. Cl. 709/220; 709/224

(57) ABSTRACT

A method for managing a network includes selecting a first database containing a topology of the network, as an active database that is accessible, selecting a second database as a working database for receiving topology updates, discovering a topology of the network and updating the second database with the discovered topology, and selecting the second database as the active database. Another method includes discovering the network, updating a topology representation of the network in a working database based on the discovering, simultaneous with the discovering and the updating providing access to a topology representation of the network in an active database, and exchanging connections of the working and active databases.

### BACKGROUND

A known network discovery solution, for example Hewlett Packard Company's Network Node Manager Extended Topology (NNM/ET) version 1.5, achieves accurate connectivity discovery of a network. However, the discovered data can require analyzation as a whole chunk or body that spans multiple connected devices. In addition, during the discovery process the discovered topology can go through many stages, and may be in a consistent state only in the last stage. The topology in the intermediate stages of the discovery may be inaccurate and inconsistent. Accordingly, as in NNM/ET version 1.5, the topology may not be available or made available during the discovery process. Depending on the complexity of the network undergoing discovery, the discovery process can take hours or even days to complete.

### SUMMARY

An exemplary method for managing a network using a plurality of databases includes selecting a first one of the plurality of databases that contains a topology of the network, as an active database that is accessible, selecting a second one of the plurality of databases that contains a topology of the network, as a working database for receiving topology updates, discovering a topology of the network, and updating the second database with the discovered topology, and selecting the second database as the active database.

An exemplary method for managing a network using a plurality of databases includes discovering the network, updating a topology representation of the network in a working database based on the discovering, simultaneous with the discovering and the updating, providing access to a topology representation of the network in an active database, and exchanging connections of the working and active databases.

An exemplary method for managing a network using a plurality of databases includes connecting a first one of the plurality of databases that contains a topology of the network, as an active database accessible by clients, connecting a second one of the plurality of databases that contains a topology of the network, as a working database for receiving topology updates, discovering a topology of the network and updating the working database with the discovered topology, connecting the working database as the active database, and connecting one of the plurality of databases as the working database, wherein the database connected as the active database and the database connected as the working database are different databases.

A machine readable medium can include software or a computer program or programs for causing a computing device to perform the exemplary methods.

An exemplary system for managing a network using a plurality of databases includes means for discovering a topology of the network and updating a topology of the network in a database connected to the means for discovering, means for connecting the means for discovering to a first database while at the same time connecting clients to a second database containing a topology of the network, and for connecting the clients to the first database after the means for discovering updates the topology of the network.

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements and:

FIG. 1 is a flow diagram of an exemplary method.

FIG. 2 is a flow diagram of an exemplary method.

FIGS. 3A-C show different database connections consistent with exemplary methods.

FIG. 4 shows an exemplary system.

### DETAILED DESCRIPTION

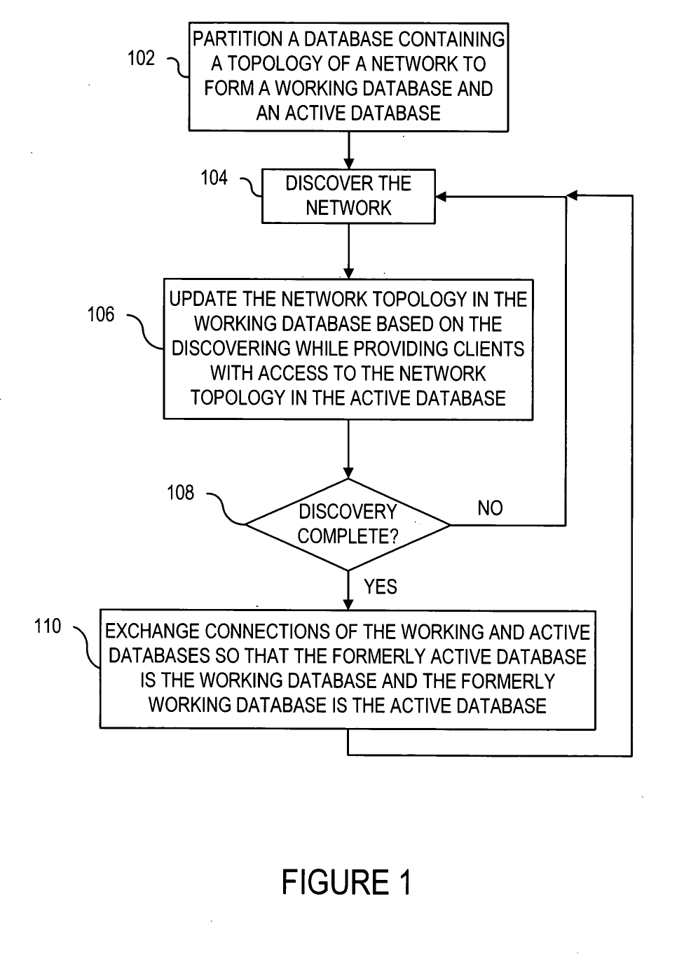

FIG. 1 illustrates an exemplary method for managing a network. This method can allow the network to remain available during the discovery process, can allow the network topology to be easily backed up, and can allow health of the network to be monitored during the discovery process.

As shown in FIG. 1, in a first block 102, a database containing a topology of the network is partitioned to form a working database and an active database. The contents of the working and active databases can be identical. For example, the working database and the active database can contain the same representation of the network's topology. “Database” as used herein indicates one or more structured sets of data, for example persistent data. The structure can for example be formed by one or more of an order or sequence of the data, a format of the data, and/or by metadata associated with elements or subsets of the data, and/or other mechanism or scheme.

From block 102, control proceeds to block 104, where the network discovery commences. From block 104, control proceeds to block 106, where the network topology in the working database is updated based on results of the discovery process of block 104, while at the same time clients, users and/or other entities are provided with access to the network topology in the active database. From block 106, control proceeds to block 108, where a determination is made whether discovery of the network is complete. If not, then control returns to block 104 and the cycle repeats. If yes, then control proceeds to block 110. In block 110, connections of the working and active databases are exchanged so that the old or formerly active database is the working database, and the old or formerly working database is the active database. Thus the clients, users and/or other entities now can have access to a fresh and accurate topology representation. As shown in FIG. 1, from block 110, control can return to block 104 to start a new discovery of the network that will update the old active database with fresh network topology information from the new discovery.

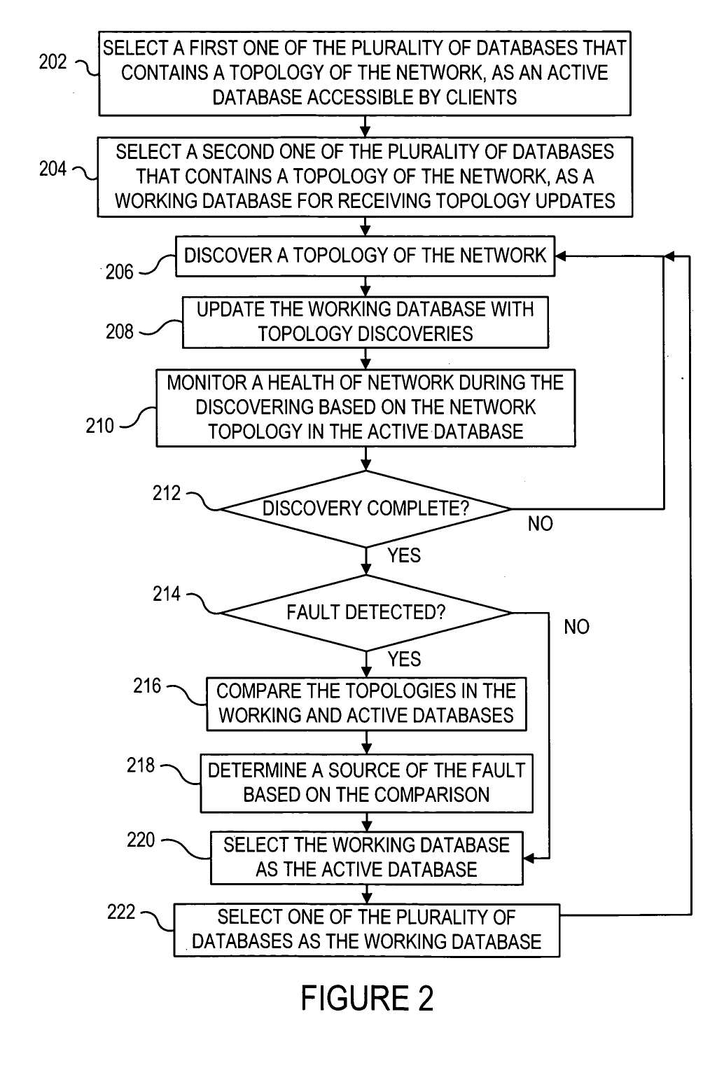

FIG. 2 illustrates another exemplary method. In a first block 202, a first one of a plurality of databases that contains a topology of a network is connected as an active database so that the topology is accessible, for example by clients, users and/or other entities. A client can be, for example, a device, computer or program that can download files for manipulation, run applications, or request application-based services from a file server. From block 202, control proceeds to block 204, where a second one of the plurality of databases that contains a topology of the network is selected or connected, e.g., associated, as a working database for receiving technology updates. From block 204, control proceeds to block 206, where a topology of the network is discovered. From block 206, control proceeds to block 208, where the working database is updated with the topology discoveries, for example topology information discovered in block 206. From block 208, control proceeds to block 210, where a health of the network is monitored during the discovering of the network, based on the network topology contained in the active database.

From block 210, control proceeds to block 212, where a determination is made whether discovery of the network is complete. If no, then control returns to block 206. If yes, then control proceeds from block 212 to block 214. If in block 214 a fault such as a network fault is detected, then control proceeds to block 216, where the topologies of the working and active databases are compared. From block 216, control proceeds to block 218, where a source of the fault is determined based on the comparison. From block 218, control proceeds to block 220. If at block 214 no fault is detected, then control proceeds directly from block 214 to block 220. In block 220, the working database is connected or selected as the active database, and control proceeds to block 222. In block 222, one of the plurality of databases is connected or selected as the working database. Upon completion of block 222, the databases selected or connected as the working and active databases can be different databases. The database selected or connected as the working database in block 222 can be, for example, the first one of the plurality of databases, a database that was connected or selected as the active database immediately before being connected or selected as the working database in block 222, or can be a third database that is different from the active and working databases of blocks 208-210. From block 222, control can return to block 206, to begin a new discovery and perform the process of blocks 206-222 again.

Various actions shown in FIG. 2 can be performed in a different order than that shown in FIG. 2. For example, block 210 as well as the sequence of blocks 214-218 can be performed at any time.

With respect to the exemplary methods of FIGS. 1-2, the connection exchange or reselection of the databases can take place after a complete discovery of the network, or after a partial discovery of the network, for example a partial discovery that results in an updated topology that is consistent even though it might not include all updates that a complete discovery might provide. The network topology in the working database can also be updated to reflect the network topology in the active database, for example after selections or connections of the working and active databases are exchanged or re-arranged and before a fresh round of discovery begins.

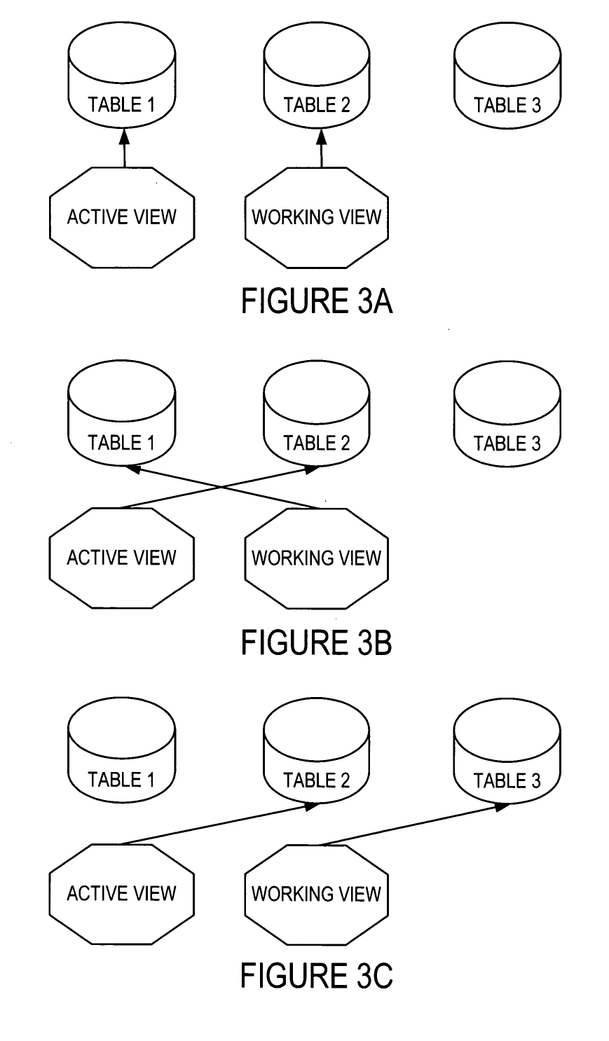

FIGS. 3A-3C show different database configurations consistent with the processes described herein. FIG. 3A shows an initial configuration where an active “view” is connected to or associated with a first database or table 1, and a working “view” is connected to or associated with a second database or table 2, and a third database or table 3 is not connected to or associated with either the active view or the working view. As used herein, a “view” is a defined access to a database. For example, presence of the active view of FIG. 3A indicates that the first database or table 1 is connected or selected to be an “active” database that includes a network topology and is accessible, for example to clients or other entities, consistent with the processes described herein. Presence of the working view indicates that the database connected to, or accessed in accordance with, that view contains a network topology that is updated with information provided by discovery of the network.

FIG. 3A shows a first configuration, for example the situation present upon completion of block 204 of FIG. 2. FIG. 3B shows a situation where the active view is connected to or associated with the second database or table 2, and the working view is connected to or associated with the first database or table 1, as for example upon completion of block 110 of FIG. 1 or block 222 of FIG. 2. FIG. 3C shows an alternative configuration where the active view is connected to or associated with the second database or table 2, and the working view is connected to or associated with the third database or table 3, as for example upon completion of block 222 of FIG. 2. Thus, for example, upon completion of discovery the database connections can switch from the configuration of FIG. 3A to that of FIG. 3B or vice versa, can shift from the configuration of FIG. 3A to that of FIG. 3C, and so forth. In a situation where FIG. 3C is the configuration during discovery (or a discovery cycle), then upon completion of discovery (or the discovery cycle) the active view can be connected to or associated with the third database or table 3, the working view can be connected to or associated with the first database or table 1, so that the databases can be rotated among the views. More than three databases can be used, as well as different rotational schemes, for example consistent with the process shown in FIG. 2.

An exemplary schema for implementing a database, for example the working database or the active database, can include a table used to store network information about nodes in the network, e.g. a table “NWNode”. The following chart illustrates the schema implementation of this relational database table. Also shown below is how the topology database can be partitioned into two identical databases with the exact same set of tables for NWNode table.

create table NWNode_1 (

EntityName VARCHAR(255) not null,
ObjID CHAR(36) not null,
IPLevel INTEGER null,
SysOID VARCHAR(64) null,
CreateTimeUTC INTEGER null,
ChangeTimeUTC INTEGER null,
AscChangeTime INTEGER null,
SNMPState INTEGER null,
Status INTEGER null,
V6CompoundStatus INTEGER null,
V6GlobalStatus INTEGER null,
V6SiteStatus INTEGER null,
hasDynamicProperty INTEGER null,
NNMObjID VARCHAR(36) null,
V4ManagementAddress VARCHAR(15) null,
V4ManagementAddressRD INTEGER null,
PubV4ManagementAdd VARCHAR(15) null,
SysContact VARCHAR(128) null,
SysLocation VARCHAR(128) null,
L2DomainId INTEGER null,
hasAddress INTEGER null,
StatusChangeTimeUTC INTEGER null,
EntityType INTEGER null,
Description VARCHAR(2000) null,
ZoneNumber VARCHAR(128) null,
isATM INTEGER null,
isOSPF INTEGER null,
isBGP INTEGER null,
isHSRP INTEGER null,
isFrameRelay INTEGER null,
isMultiHome INTEGER null,
isMPLS INTEGER null,
isLanSwitch INTEGER null,
isManageable INTEGER null,
isIPV6Router INTEGER null,
isIPV4Router INTEGER null,
isSTP INTEGER null,
isVRRP INTEGER null,
isWireless INTEGER null,
isRMON INTEGER null,
isRMON2 INTEGER null,
isDS1 INTEGER null,
isDS3 INTEGER null,
isSONET INTEGER null,
isCDP INTEGER null,
isSNMPSupported INTEGER null,
toBeCompared INTEGER null, PRIMARY KEY (ObjID) );

create table NWNode_2 (

EntityName VARCHAR(255) not null,
ObjID CHAR(36) not null,
IPLevel INTEGER null,
SysOID VARCHAR(64) null,
CreateTimeUTC INTEGER null,
ChangeTimeUTC INTEGER null,
AscChangeTime INTEGER null,
SNMPState INTEGER null,
Status INTEGER null,
V6CompoundStatus INTEGER null,
V6GlobalStatus INTEGER null,
V6SiteStatus INTEGER null,
hasDynamicProperty INTEGER null,
NNMObjID VARCHAR(36) null,
V4ManagementAddress VARCHAR(15) null,
V4ManagementAddressRD INTEGER null,
PubV4ManagementAdd VARCHAR(15) null,
SysContact VARCHAR(128) null,
SysLocation VARCHAR(128) null,
L2DomainId INTEGER null,
hasAddress INTEGER null,
StatusChangeTimeUTC INTEGER null,
EntityType INTEGER null,
Description VARCHAR(2000) null,
ZoneNumber VARCHAR(128) null,
isATM INTEGER null,
isOSPF INTEGER null,
isBGP INTEGER null,
isHSRP INTEGER null,
isFrameRelay INTEGER null,
isMultiHome INTEGER null,
isMPLS INTEGER null,
isLanSwitch INTEGER null,
isManageable INTEGER null,
isIPV6Router INTEGER null,
isIPV4Router INTEGER null,
isSTP INTEGER null,
isVRRP INTEGER null,
isWireless INTEGER null,
isRMON INTEGER null,
isRMON2 INTEGER null,
isDS1 INTEGER null,
isDS3 INTEGER null,
isSONET INTEGER null,
isCDP INTEGER null,
isSNMPSupported INTEGER null,
toBeCompared INTEGER null, PRIMARY KEY (ObjID) ).

The contents of the two tables after two discoveries can, for example, be:
NWNode_{—}1 (mcrouter81.cnd.hp.com, c64190d6-40ad-71 d8-1ef7-0f0271c20000,4, 1.3.6.1.4.1.9.1.110, 1074037977, 1074037977,NULL,NULL,1,1,1,1,0,1706,15.2.32.85,0,15.2.32.85, Jim Scheller, X87691, 5U E. Computer Room,−1,0,0,1, Cisco Internetwork Operating System Software
IOS (tm) 3600 Software (C3640-I-M), Version 12.2(1), RELEASE SOFTWARE (fc2)
Copyright (c) 1986-2001 by cisco Systems, Inc.,1,0,1,0,0,1,0,0,0,0,0,1,0,0,0,0,0,0,0,0,1,1,1), and
NWNode_{—}2 (mcrouter81.cnd.hp.com, c64190d6-40ad-71 d8-1ef7-0f0271c20000,4, 1.3.6.1.4.1.9.1.110, 1073437610, 1073437610,NULL,NULL,1,1,1,1,0,1706,15.2.32.85,0,15.2.32.85, Kelly Smith, X87342, 5U E. Computer Room,−1,0,0,1, Cisco Internetwork Operating System Software
IOS (tm) 3600 Software (C3640-I-M), Version 12.2(1), RELEASE SOFTWARE (fc2)
Copyright (c) 1986-2001 by cisco Systems, Inc., 1,0,1,0,0,1,0,0,0,0,0,1,0,0,0,0,0,0,0,0,1,1,1).

Note for example the differences in content of NWNode_{—}1 and NWNode_{—}2, which can be summarized in the following Table 1.

TABLE 1

| Column that is | | |
|---|---|---|
| different | NWNode_1 value | NWNode_2 value |
| SysContact | Jim Scheller, | Kelly Smith, |
| | X87691 | X87342 |
| CreateTimeUTC | 1074037977 | 1073437610 |
| ChangeTimeUTC | 1074037977 | 1073437610 |

Actual switching of the database connections can be implemented, for example, using the following pseudocode:
Discovery process sends the information that discovery is complete.
Topology process gets the view number that is active from the database.
Set the Database in READ ONLY mode.//i.e. no one can write anything in database now.
Send notification that database is in READ ONLY mode.//i.e. If any process fails to write in DB, they would understand the reason for failure in the above step.
Execute the Switching View activity.
Drop the view. (Example of SQL statements: “drop view NWNode_update;” and “drop view NWNode;”)
Create the necessary Active View. (Example of SQL statements: “create view NWNode as select * from NWNode_{—}1;”)
Create the necessary Working View. (Example of SQL statements: “create view NWNode_update as select * from NWNode_{—}2;”
Update the active view number in Database.
Set the Database in READ-WRITE mode.
Send the notification that database is is READ-WRITE mode.//i.e. Now database is ready for writing purpose.

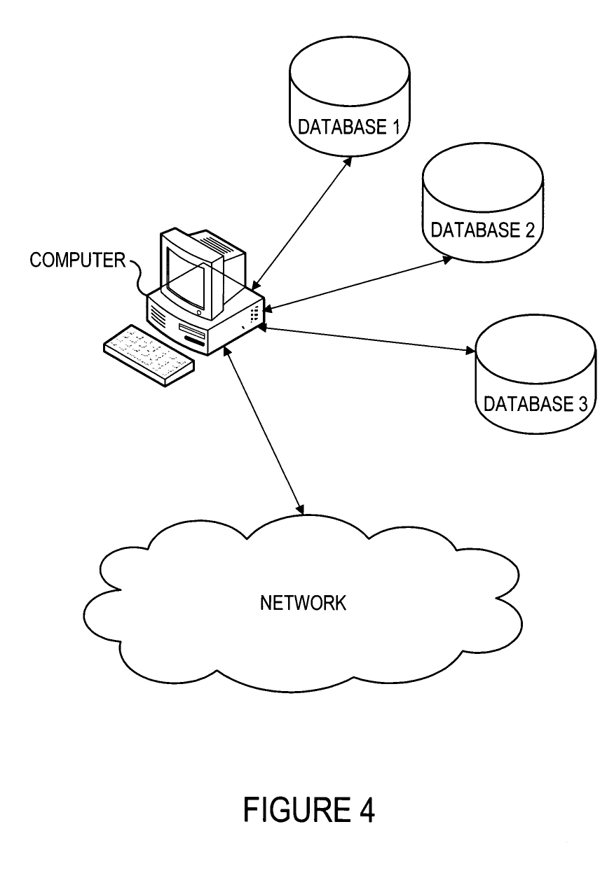

FIG. 4 illustrates an exemplary system for managing a network using a plurality of databases, for example the databases 1-3 of FIG. 4, including means for discovering a topology of the network and updating a topology of the network in a database connected to the means for discovering, and means for connecting the means for discovering to a first database while at the same time connecting clients to a second database containing a topology of the network, and for connecting the clients to the first database after the means for discovering updates the topology of the network.

The means for discovering and updating can be implemented via software operating on the computer connected to the three databases 1, 2, 3 and the network. The computer can include software for discovering the network, for example a topology of the network, and can also include software for maintaining topology representations of the network, for example in the databases 1, 2, 3 consistent with the processes described herein. The means for connecting can also be implemented via software operating on the computer, and/or can include switches or interfaces implemented with hardware and/or software to connect or select the databases as working and active databases, and disconnect or deselect databases.

One of the three databases can be connected as an active database that contains a topology of the network and is accessible, for example accessible, for example to clients or other entities. The active database can be accessed via the computer or via one or more direct connections to the active database or in other ways. Another of the three databases can be connected as the working database, Wherein software on the computer receives information from an ongoing discovery of the network and updates the network topology in the working database with the received information. The discovery software and/or the software for accessing and updating the databases can be software operating on the computer and/or software agents operating on the network using network resources.

The databases 1, 2, 3 can be fileservers external to the computer, can be embodied in separate hard disk drives that are internal or external to the computer, can be embodied as different partitions or portions of a single hard disk drive or other data storage device, or can each be distributed among multiple devices, and so forth.

Software packages, elements or modules for variously providing access or views to the databases, e.g. for connecting clients to an active database and for connecting a discovery process to the working database, for maintaining the network topologies in the databases, and/or for performing other process functions described herein, can be implemented on the computer. For example, the processes such as discovering the network, monitoring a health of the network, detecting malfunctions or faults in the network, comparing topologies from different databases and troubleshooting detected malfunctions or faults, for example based on the topology comparison, can be variously implemented separately or jointly by software or software modules or elements running on the computer. These software processes running on the computer can be additionally or alternatively be implemented in a distributed fashion external to the network using for example distributed computing resources, and/or can be implemented using resources of the network.

Thus, the methods, logics, techniques and pseudocode sequences described above can be implemented in a variety of programming styles (for example Structured Programming, Object-Oriented Programming, and so forth) and in a variety of different programming languages (for example Java, C, C++, C#, Pascal, Ada, and so forth). In addition, those skilled in the art will appreciate that the elements and methods or processes described herein can be implemented using a microprocessor, computer, or any other computing device, and can be implemented in hardware and/or software, in a single physical location or in distributed fashion among various locations or host computing platforms. Agents can be implemented in hardware and/or software or computer program(s) at any desired or appropriate location. Those skilled in the art will also appreciate that software or computer program(s) can be stored on a machine-readable medium, wherein the software or computer program(s) includes instructions for causing a computing device such as a computer, computer system, microprocessor, or other computing device, to perform the methods or processes.

The exemplary processes and systems described herein can provide multiple advantages. A consistent topology can be made accessible at all times, for example to clients, users or other entities. In addition, exemplary embodiments can detect changes that have occurred across two consecutive discovery cycles. This information can be used very effectively to troubleshoot the network problems and diagnose the health of the network.

For example, consider a problem wherein during a first discovery, a certain number of STPs (Spanning Tree Protocols) are discovered. Thereafter some new switches with more STPs are added to the network, and then a second discovery is completed. Now assume that one or more of the new switches or other components of the network is incorrectly configured. Due to the addition of the new switches and due to the incorrect configuration, the network experiences network congestion due to more loops in the network. In accordance with exemplary embodiments and processes, the exact changes in the network can be determined, for example by comparing the network topologies in the working and active databases to discern what new switches have been added, as well as their connectivity information. This information can be analyzed to determine if and how the switches may have been incorrectly configured, so that the problem can be corrected to improve or restore performance of the network.

In addition, exemplary embodiments can enable more accurate information about the topology of the network. For example, Layer 2 connectivity can be detected while the discovery is going on, but the connectivity value can change during discovery. Exemplary embodiments described herein can handle such a change in the connectivity value without causing inconsistency in the database for the clients of the database. This is due to the fact that the clients are accessing the active database, which remains consistent, while changes such as connectivity value changes are made in the working database.

In addition, exemplary embodiments enable the network topology to be backed up at any time, for example during discovery from the active database. This backup or snapshot of the network topology can be used during troubleshooting time.

In exemplary embodiments, connections of the active and working databases are switched or reconfigured as described herein, for example by switching views, instead of copying or swapping contents among the active and working databases. Thus, topology down time can be minimized.

Exemplary embodiments described herein also enable monitoring of devices in the network while discovery of the network is in progress. This allows the health of the network to be monitored and troubleshot during discovery process.

It will also be appreciated by those skilled in the art that the present invention can be embodied in other specific forms without departing from the spirit or essential characteristics thereof, and that the invention is not limited to the specific embodiments described herein. The presently disclosed embodiments are therefore considered in all respects to be illustrative and not restrictive. The scope of the invention is indicated by the appended claims rather than the foregoing description, and all changes that come within the meaning and range and equivalents thereof are intended to be embraced therein.

1. A method for managing a network using a plurality of databases, the method comprising:
selecting a first one of the plurality of databases that contains a topology of the network, as an active database that is accessible;
selecting a second one of the plurality of databases that contains a topology of the network, as a working database for receiving topology updates;
discovering a topology of the network, and updating the second database with the discovered topology; and
selecting the second database as the active database.

2. The method of claim 1, wherein before discovering the topology of the network, the active database and the working database contain identical topologies of the network.

3. The method of claim 1, comprising:
selecting the first database as the working database;
discovering a topology of the network, and updating the first database with the discovered topology; and
selecting the first database as the active database.

4. The method of claim 1, comprising:
selecting a third one of the plurality of databases as the working database;
discovering a topology of the network, and updating the third database with the discovered topology; and
selecting the third database as the active database.

5. The method of claim 1, comprising:
monitoring a health of the network during the discovering based on the network topology in the active database.

6. The method of claim 1, wherein the discovering returns a connectivity of the network.

7. The method of claim 6, wherein the discovering returns a Layer 2 connectivity of the network.

8. The method of claim 1, comprising:
detecting a fault in the network;
comparing the topologies in the working and active databases;
determining a source of the fault based on the comparing.

9. A method for managing a network using a plurality of databases, the method comprising:
discovering the network;
updating a topology representation of the network in a working database based on the discovering;
simultaneous with the discovering and the updating, providing access to a topology representation of the network in an active database; and
exchanging connections of the working and active databases.

10. The method of claim 9, comprising:
repeating the discovering, updating, providing, and exchanging.

11. The method of claim 9, wherein the exchanging is performed upon completion of the discovering of the network and updating the topology representation,

12. The method of claim 9, comprising partitioning a topology database to form the working database and the active database.

13. A system for managing a network using a plurality of databases, the system comprising:
means for discovering a topology of the network and updating a topology of the network in a database connected to the means for discovering;
means for connecting the means for discovering to a first database while at the same time connecting clients to a second database containing a topology of the network, and for connecting the clients to the first database after the means for discovering updates the topology of the network.

14. The system of claim 13, wherein the means for connecting exchanges connections of the first and second databases among the means for discovering and the clients after the means for discovering completes discovery of the network.

15. The system of claim 13, wherein after the means for discovering completes discovery of the network, the means for connecting reconnects the clients from the second database to the first database and connects the means for discovering to a third database.

16. The system of claim 13, comprising means for monitoring a health of the network based on the network topology in the second database.

17. The system of claim 13, comprising means for detecting a fault in the network, comparing the topologies in the first and second databases, and determining a source of the fault based on the comparing.

18. A machine readable medium comprising a computer program for causing a computer to perform:
selecting a first one of the plurality of databases that contains a topology of the network, as an active database accessible by clients;
selecting a second one of the plurality of databases that contains a topology of the network, as a working database for receiving topology updates;
discovering a topology of the network, and updating the second database with the discovered topology; and
selecting the second database as the active database.

19. The medium of claim 18, wherein the computer program causes the computer to perform:
selecting the first database as with the working database;
discovering a topology of the network, and updating the first database with the discovered topology; and
selecting the first database as the active database.

20. The medium of claim 18, wherein the computer program causes the computer to perform:
selecting a third one of the plurality of databases as the working database;
discovering a topology of the network, and updating the third database with the discovered topology; and
selecting the third database as the active database.

21. The medium of claim 18, wherein the computer program causes the computer to perform:
monitoring a health of the network during the discovering based on the network topology in the active database

22. A machine readable medium comprising a computer program for causing a computer to perform
discovering the network;
updating a topology representation of the network in a working database based on the discovering;
simultaneous with the discovering and the updating, providing access to a topology representation of the network in an active database; and
exchanging connections of the working and active databases.

23. The medium of claim 22, wherein the computer program causes the computer to perform:
repeating the discovering, updating, providing, and exchanging.

24. A method for managing a network using a plurality of databases, the method comprising:
connecting a first one of the plurality of databases that contains a topology of the network, as an active database accessible by clients;
connecting a second one of the plurality of databases that contains a topology of the network, as a working database for receiving topology updates;
discovering a topology of the network, and updating the working database with the discovered topology;
connecting the working database as the active database; and
connecting one of the plurality of databases as the working database, wherein the database connected as the active database and the database connected as the working database are different databases.

25. The method of claim 24, comprising:
repeating the discovering of the network and the updating of the working database, the connecting of the working database as the active database, and the connecting of one of the plurality of databases as the working database.
